(19) United States
(12) Patent Application Publication
(10) Pub. No.: US 2025/0019524 A1
(43) Pub. Date: Jan. 16, 2025

(54) ENHANCED UTILISATION OF MICROALGAE BIOMASS

(71) Applicant: MAREA ehf., Reykjavik (IS)

(72) Inventors: Manoj Saravana Guru Mohan Ram, Reykjavik (IS); Julie Encausse, Reykjavik (IS)

(21) Appl. No.: 18/433,915

(22) Filed: Feb. 6, 2024

(30) Foreign Application Priority Data
Jul. 14, 2023 (IS) 050564

(51) Int. Cl. C08L 5/00; C08H 8/00

(52) U.S. Cl. CPC C08L 5/00; C08H 8/00

(57) ABSTRACT

Methods for extracting from microalgae biomass valuable biomaterials, including polysaccharides, which can be used as coatings (biofilms) and other applications are described. The methods provide for partial separation of biomaterials into fractions enriched in different materials, which increases the utility and value of the original biomass, including a protein-enriched fraction, a polysaccharide-enriched fraction, and a lignin-rich fraction. By using the methods of the invention, a biomass source which is currently underutilized can be refined and processed into higher value products, leaving very little or no left-over residue material. The methods can advantageously be used for utilization and valuation of left-over biomass after astaxanthin extraction from microalgae.

### CROSS-REFERENCE TO RELATED APPLICATION

This claims the benefit of priority from Iceland Application No. 050564, filed Jul. 14, 2023, which is incorporated by reference in its entirety.

### FIELD

The invention is in the field of biomaterial production and relates to a method for extracting from microalgae fractions that are enriched in starch, polysaccharides, protein and lignin. The obtained materials can be used in making edible biofilm and bioplastics.

### BACKGROUND

Microalgae are useful sources of high-value biomaterial products like proteins, polysaccharides, lipids, pigments, vitamins, and minerals, with potential health benefits. Several cultivation methods are reported in the scientific literature to enhance production of bioactive products from various algae and to study their biomass potential for high-value products.

Pigments are currently the most relevant product produced by microalgae for industry, due to their large spectrum of applications in health and in food (Patel et al., 2022). Microalgae biomass can produce different pigments like xanthophylls that are oxy-carotenoids; astaxanthin is one of the most recognized algae xanthophylls which is largely produced by H. pluvialis (Patel et al., 2022). Astaxanthin is considered a high-potential antioxidant and H. pluvialis is the dominant source of this pigment. H. pluvialis can accumulate up to 5% of its dry weight (Ren et al., 2021; Shah, Liang, Cheng, & Daroch, 2016).

After the production and extraction of astaxanthin, the leftover biomass and free media, have potential to be used as a source of other products though little is found in the art about possible co-products or by-products that could be used for valorization for the food industry or related fields. Studies have been conducted on H. pluvialis but none that we are aware of on the leftover biomass of H. pluvialis after astaxanthin extraction. In commercial astaxanthin production from H. pluvialis, the left-over biomass has simply represented a low-value by-product stream that companies face the challenge of disposing or using.

Conventional astaxanthin extraction from H. pluvialis typically comprises rupturing the outer cellular walls and extraction, such as by supercritical fluid (SCF) extraction (e.g. using CO₂), of the astaxanthin component, leaving 95% or more of the biomass as left-over by-product.

Li et al. (2011) explored the large-scale potential of algae-free media of H. pluvialis to release extracellular polymeric substances (EPS) and realised that using ultrafiltration method, EPS were obtained and revealed capacity of inhibiting tumour cell growth, demonstrating the feasibility of ultrafiltration of unused media from commercial H. pluvialis cultures to be used for biomedical applications.

Liu et al. (2018) characterised a polysaccharide fraction (HPP-c3-s1) from H. pluvialis and evaluated its biological activity. It was reported that treatment with HPP-c3-s1 resulted in delays in age-related physiological parameters like body movement, head swing and body bending, and accumulation of C. elegans, suggesting remarkable immunomodulatory and anti-aging properties with potential to serve as basis for functional foods and dietary supplements.

Starch was isolated from H. pluvialis by Hirst, Manners, & Pennie (1972) and fractionated into amylopectin very similar to potato amylopectin and amylose (22%).

Molino et al. (2018) characterised H. pluvialis and reported production of proteins, 25% “red phase” and 33% “green phase” on a dry basis. Studies reported in the literature show that a decrease in nitrogen concentration during cultivation leads to lipids and polysaccharides production (Dolganyuk et al., 2020).

### SUMMARY

The present invention provides new efficient methods for extracting from microalgae biomass valuable biomaterials, including polysaccharides, that can be used as coatings (biofilms) and other applications. The method provided herein provides partial separation of biomaterials into fractions enriched in different materials, that increases the utility and value of the original biomass. Thus the method herein provides at least a protein-enriched fraction, a polysaccharide-enriched fraction and a lignin-rich fraction. Accordingly, the invention provides in a further aspect, enriched fractions from microalgae biomass comprising a protein-rich fraction, which is a useful protein source for various applications such as in foodstuff and animal feed, and a polysaccharide fraction rich in starch, and advantageously as well a fraction rich in cellulose and hemicellulose. Thus, by the methods of the invention, a biomass source which is currently underutilised can be refined and processed into higher value products, leaving very little or no left-over residue material.

### BRIEF DESCRIPTION OF THE DRAWING

FIG. 1 is a flowchart depicting an example of the method.

### DETAILED DESCRIPTION

The present methods enable extraction and provision of valuable bioproducts with good film-forming properties, provision of higher yields of acid-soluble polysaccharides than with other extraction methods in the art, and limits degradation of bioproducts. With the present invention, the bulk and preferably all of left-over biomass such as residue after astaxanthin extraction, is utilised as higher-value products than what is currently practised in the art. The invention thus provides beneficial valorization and utilization of a biomaterial by-product that hitherto has been of low value.

In a first aspect, the invention provides a method for obtaining biomaterials from spent microalgae biomass, comprising
providing microalgae biomass such as residue after astaxanthin extraction,
a first extraction in weak or mild acid to obtain a first supernatant with acid soluble materials including starch, and a first residue of acid-insoluble material,
a second extraction of said first residue by mild-alkali solution for extraction of mild-base soluble materials to obtain a second supernatant with mild-base soluble materials including proteins and lignins, some polysaccharides and a second residue, which includes lignins and saccharides (cellulose and hemicellulose),
a third extraction with strong base for extraction from said second residue of a third supernatant comprising cellulose, hemicellulose and lignins, and preferably also
a fourth step comprising lignin recovery from one or both of said second and third supernatant with alcoholic solution, to recover a soluble fraction comprising lignins.

The fourth step makes lignins soluble and hence provides one or two precipitated fractions; when the second supernatant (from Step 2) is subjected to the lignin recovery step (also referred to as delignification) protein-rich material is precipitated, but preferably, as described herein below, the second supernatant is first re-acidified as described below as ‘Step 5’, and the precipitate resulting therefrom (‘Residue III’) then subjected to delignification, by suspending in alkaline alcohol solution (described below as ‘Step 4a’). When the third supernatant, i.e. the supernatant (or filtrate) from Step 4, is delignified by mixing with ethanol, lignins are soluble and a fifth residue obtained comprising cellulose and hemicellulose.

As discussed above, the method is particularly useful for left-over biomass from astaxanthin extraction from microalgae such as H. pluvialis, but in principle the method can be applied to other comparable microalgae biomass.

Left-over biomass from astaxanthin extraction typically comprises algae biomass where cells have been ruptured and undergone extraction such as e.g. supercritical CO₂ extraction. Thus, starting material for the present invention, whether from spent H. pluvialis mass or other microalgae source, preferably comprises biomass with ruptured cells, alternatively, the process of the invention may be complemented with a step of rupturing the microalgae cells, such as with but not limited to salt-induced osmosis and/or ultrasonication.

The first extraction is performed with acidic solution from weak or mild acid, indicating an acidic solution with pH above about 3 and preferably above about 4, such as in the range from about 3 or from about 3.5 or from about 4, to about 6 or to about 5.5 or to about 5. (“Weak acid” refers to the general chemical term defining an acid that does not have a strong electron-donating capacity, and thus a weak acid used herein requires higher concentration compared to strong acid, whereas “mild acid” refers to an acid, weak or strong, that is in a concentration so as to provide a mild acidic pH, such as within the ranges mentioned.) The acid is preferably an acid which is safe for human intake (in dilution) and can, for example, be selected from, but is not limited to, a weak acid such as acetic acid, citric acid, tartaric acid, lactic acid and malic acid, but low concentration strong acids can also be used, such as but not limited to diluted hydrochloric acid (HCl) and sulfuric acid (H₂SO₄). The starting material biomass is suspended in the acid as a slurry with, for example, in the range of 5-10% of dry weight biomass material. The first extraction is preferably performed with applying ultrasonication, such as in conventional ultrasonic extractor. Ultrasonication can, for example, be applied with intermittent pulses. Ultrasonication provides efficient extraction and a pulse cycle ensures that the temperature of the mix is maintained within a suitable range, preferably within a range from about 30-50° C. and more preferably within the range 30-45° C. and yet more preferably 30-40° C. The ultrasonication will also further promote rupturing of cell wall material (“crushing” the cells).

After a period of time, the suspended materials are subjected to a separation for separating solid residue from solubilised materials. This is preferably and advantageously done with centrifugation. In other embodiments ultrafiltration is used for the separation. Thereby is obtained a first supernatant (or filtrate) and a first solid residue. The mentioned period of time is in some embodiments in the range from 30-180 minutes, such as in a range from about 30, or from about 45 or from about 60 minutes, to about 180 minutes, or to about 150 minutes, or to about 120 minutes or to about 100 minutes or to about 90 minutes.

In the context herein, for simplicity “supernatant” refers to the obtained liquid phase from a separation of liquid and solids, whether or not the separation is performed with centrifugation/precipitation or by filtration (in which case the respective recovered liquid phase is strictly a filtrate rather than a supernatant).

The first residue may be re-extracted, by re-suspending in weak or mild acid at desired pH range, agitating (preferably ultrasonicating) for the same or different period of time as for the initial suspending, and centrifuging/filtering again.

The obtained supernatant or filtrate (referred to as first supernatant or supernatant I) comprises materials which are soluble in mild acid and will typically comprise a content of starch and can comprise as main component starch, and may further comprise protein, cellulose and some hemi-cellulose.

The first residue (Residue I) is then subjected to the second stage of processing (“Step 2”), which comprises a step of suspending in mild-alkali solution and extracting therefrom a second supernatant and a second residue. The term “mild alkali solution” refers to a basic solution with a mild basic pH, i.e. a pH typically less than about 9. The mild-alkali solution preferably has a pH in the range from about 7 to about 8, such as in range from about 7 to about 7.8 or to about 7.7 or to about 7.6 or to about 7.5, such as a pH of about 7.2 or about 7.3 or about 7.4 or about 7.5. The mild alkali suspending solution may be made up with a suitable strong or weak base, such as sodium hydroxide, potassium hydroxide, ammonium hydroxide, sodium bicarbonate, calcium hydroxide, sodium carbonate, barium hydroxide, or an organic base such as but not limited to guanidine, methylamine.

In preferred embodiments the suspending in mild alkali is performed substantially similar as the preceding step of mild acid extraction. Thus, the suspending may preferably comprise ultrasonication, preferably as described above for the preceding step. After suspending for the desired period of time, preferably a time period which is the same or similar to the time period used in the preceding step, or a time period within the ranges mentioned above for the preceding step, the suspension is subjected to separation, for separating solid residue from solubilised materials. This is preferably and advantageously done with filtration such as ultrafiltration or centrifugation. Thereby is obtained a second supernatant or filtrate and a second solid residue.

The obtained solid residue is preferably re-extracted, i.e. rinsed with the same or similar mild alkali solution as was used in the main suspending step, re-agitated (preferably re-ultrasonicated) for a period of time, and then again subjected to separation and the obtained supernatant pooled with the previous obtained second supernatant (filtrate).

The obtained final residue from the second step (“second residue”—residue II) is subjected to a third step (“Step 3”) of suspending and subsequent liquid-solid separation, with a strong base/high pH solution. The strong base preferably is a basic solution with a pH in the range from 9 to 14 such as in the range from about 9 or from about 9.5 or from about 10, or from about 10.5 or from about 11, to about 14 or to about 13 or to about 12.5 or to about 11 or to about 11.5. The strong base solution is typically made up with a conventional strong base such as NaOH or KOH, optionally including also urea. In an embodiment of the method, the strong base solution comprises in the range of about 0.5-3M urea, which can be in addition to a strong base such NaOH or KOH.

The strong base suspension is agitated, preferably with ultrasonication, advantageously performed as in the preceding steps. After a suitable period of agitation, the suspension is subjected to separation. The separation is preferably performed with ultrafiltration. Solid residue is preferably re-suspended and rinsed, preferably again ultrasonicated, and then the suspension again separated and obtained supernatants are pooled.

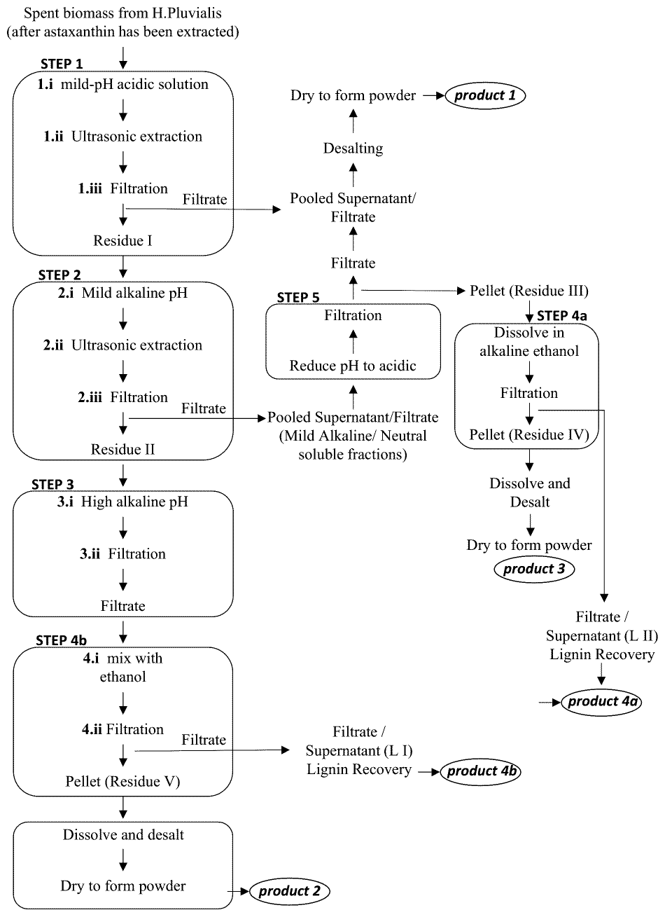

The mentioned subsequent optional fourth step achieves recovery of lignin from at least the obtained third supernatant, with alcoholic solution. This can, for example, be performed by adding to the supernatant alcoholic solvent (preferably ethanol) to obtain a solution of about 2/3 vol/vol alcohol or more such as 3/4 vol/vol alcohol, this solution is agitated for an extended period of time, preferably at least 1 hour or more, such as at least 2 hours or at least 3 hours or more, such as at least 4 hours or at least 6 hours, such as for a period of time in the range from about 1 or from about 2 or from about 3 hours, to about 10 or to about 8 or to about 6 hours (see Step 4b in FIG. 1). This ensures solubilization of lignins, which are recovered by separation of solids from the stirred suspension, such as by centrifuge or filtration, obtaining a supernatant rich in lignins (Product 4b). The obtained solid residue (Residue V) in the fourth step comprises in particular cellulose and hemicellulose. This material is referred to as ‘Product 2’ but is preferably also desalted or dried and more preferably desalted and dried, so as to obtain ‘Product 2’ in desalted powder form.

As mentioned, the method may further comprise a fifth step, in which the second supernatant (from Step 2) is treated further, by lowering the pH of said supernatant fraction, thereby solubilising acid soluble material, and separating the obtained supernatant from solids, such as by centrifugation or filtration. The thus obtained residue (Residue III) is preferably treated with alcoholic solution to recover lignins, typically in the same manner as just described for the fourth step, leaving a residue rich in proteins (Residue IV). This delignification step of Residue III is referred to as Step 4a (see FIG. 1) whereas the delignification after Step 3 is referred to as Step 4b. The solubilised lignins are recovered by separation as mentioned above and thus are obtained Residue IV (rich in proteins) and a supernatant or filtrate (rich in lignins). The obtained Residue IV is advantageously re-dissolved (n water, preferably adjusted to about neutral pH) and desalted by dialysis. The lignin fraction (LII) can be mixed with the other lignin stream (LI), and the combined product fraction can be desalted and/or dried. The obtained lignin product stream is referred to as Product 4 or (as the individual streams) Product 4a and Product 4b.

The first supernatant comprises a substantial portion of starch, with some hemi-cellulose. This obtained supernatant I may be dried down (e.g. by lyophilization) but is preferably first desalted (e.g. by dialysis). But presently preferred is to mix Supernatant I with the filtrate/supernatant obtained from the optional Step 5, as described above. That means, in such preferred embodiment, Supernatant I is pooled with Supernatant II but only after acid-precipitation therefrom of proteins and lignins.

This supernatant fraction (i.e. Supernatant I or pooled supernatant) can advantageously be further processed by adding base, such as potassium hydroxide or sodium hydroxide, and decolorising by adding hydrogen peroxide.

The method of the invention results in different useful product streams. The first supernatant is preferably pooled with an acid-soluble fraction obtained from Supernatant II, that is, when supernatant II is subjected to acidification and liquid-solid separation, as indicated in Step 5, from which is obtained an acid-soluble liquid fraction. Further, Supernatant I or the pooled fractions as described, are preferably desalted (e.g. by dialysis) and preferably dried to provide the obtained product stream in powder form. This product stream is indicated as “product 1” and has beneficial film-forming properties. The desalting and drying steps are optional steps so ‘Product 1’ may refer as well as a product which has not undergone either or both of said steps.

Accordingly, in accordance with the invention, the obtained “product 1” can be further processed by mixing with at least one food grade plasticiser to obtain a film-forming product. The film-forming product is preferably provided in powder form so that it can be reconstituted in water to provide a sprayable film-forming solution. The sprayable film-forming solution, once sprayed onto produce (e.g. fruit) and dries, creates a thin layer, fully biocompatible and edible, on the surface of the produce, which prevents or retards oxygen entry and aids delaying food spoilage. The food grade plasticiser is in some embodiments one or more of sorbitol, glycerol, mannitol, sucrose polyethylene glycol, lipid, starch, and derivatives thereof.

In some embodiments other product streams can be mixed in the film-forming product, such as ‘product 2’ and/or ‘product 3’, together with selected plasticiser. The selected product streams may be mixed in a suitable ratio according to desired characteristics of the particular desired film-forming product.

Thus, in another aspect, the invention provides an edible film-forming product, comprising one or more product streams obtainable with the method of the invention as described herein, preferably including one or more selected edible biocompatible plasticiser, e.g. one or more of the above mentioned. As describe above, the film-forming product generally will include the starch-rich fraction in ‘product 1’ but may optionally comprise also one or both of the product streams 2 and 3.

Another utility of the invention is provision of materials to be used as bioplastics or as intermediates for bioplastics production, as the invention provides useful biomaterial fractions from which a bulk of proteins from the originating source has been separated. Accordingly, for bioplastic materials, the selected product streams are one or more of ‘product 1’, ‘product 2’ and product 4, and preferably all of them. The combined fractions, that can be combined either as desalted powders, or as liquid fractions and desalted and dried as a mixture, can advantageously be compounded into pellets, that can then subsequently be moulded into biodegradable plastics or intermediate materials for plastics production.

In a further aspect the invention thus provides a biopolymer product or intermediate product comprising one or more product fraction obtainable with the method of the invention, preferably at least product fractions 1, 2 and 4.

The mentioned product 3 provides a useful protein-rich biomaterial that can advantageously be used as protein and/or amino acid source in various applications, such as but not limitation to feed materials, foodstuffs, and may be further processed such as e.g. by hydrolysation to obtain material comprising protein hydrolysate. Product 3 is preferably desalted and/or dried to powder form.

FIG. 1 shows a flowchart depicting preferred steps of the method of the invention. The above described five steps are all indicated as well as individual sub-steps (labelled as 1.i, 1.ii etc.) and other process steps. The major product streams are as well indicated and labelled as ‘product 1’ (starch-rich fraction derived from Supernatant I and preferably also acid-soluble fraction of supernatant II); ‘product 2’ (fraction rich in cellulose and hemicellulose, derived from the soluble fraction of the high-alkaline extraction in Step 3, after delignification); ‘product 3’ (protein-rich fraction derived from acid-precipitated fraction (Residue III) of the mild-alkaline filtrate (“supernatant II”) from Step 2); and ‘product 4’ (shown as separate provided product streams 4a and 4b), which are lignin-rich fractions.

### EXAMPLES

### Example 1: Extraction of Biomaterials from Left-Over Biomass (Spent Biomass) from H. pluvialis

Starting material was left-over biomass received from a commercial astaxanthin producer. The material contained ruptured H. pluvialis microalgae that had been subjected to supercritical fluid (SCF) extraction such as with CO₂. The cells had been ruptured by salt induced osmosis (plasmolysis; i.e. cell lysis by high salt), thus the starting material is rich in salt (NaCl).

The extraction process of valuable bioproducts is performed through a series of steps of ultrasonication-mediated extraction.

First (“Step 1”), acid-soluble materials are extracted from mild pH acid suspension.

Second (“Step 2”), materials soluble in mild alkali are extracted from a mild base solution, again using ultrasonication.

Third, (“Step 3”) high alkaline and urea are used for the extraction of the remaining polysaccharides.

Fourth (“Steps 4a,4b”), lignin present in the extracts is recovered by alkaline ethanol treatment (“delignification”).

Fifth (“Step 5”), in an optional step, the filtrate/supernatant from the mild alkaline extraction is reduced in pH to acidic pH to separate an acid-soluble liquid fraction that comprises polysaccharides from a precipitated fraction comprising proteins and lignins.

The polysaccharides, including the supernatant from Step 1, which is preferably pooled with the acid-soluble liquid fraction from the above Step 5, can be decolourised by hydrogen peroxide treatment and is preferably also subjected to salt removal of by ultrafiltration.

FIG. 1 depicts a flowchart of all steps.

Step 1: the starting material is suspended in acidic solution (5-50 mM acid pH in the range 3-5) approximately 8% dry weight material. The suspension is ultrasonicated (pulsing for 10 sec.) for 90 minutes, then the suspension is ultrafiltrated to separate soluble and insoluble solid material. The residue is re-suspended and the ultrasonication and ultrafiltration is repeated, and supernatants (filtrates) pooled (supernatant I).

The pooled supernatant comprising acid-soluble materials can be subjected to “delignification” and further to optional decolourization, as described above. The solid residue from the mild acid extraction is denoted as residue I.

Step 2: The residue I from the first extraction is extracted in the second step under mild alkaline condition (a pH in the range 7 to 8; adjusted with NaOH). The residue is suspended and the suspension subjected to ultrasonication, preferably using the same settings as in step 1, with cyclic pulsing for a total of 90 min. The mild alkaline soluble materials are separated from solids, by ultrafiltration or centrifugation, and the residue is resuspended and again extracted with the same conditions. The solid residue from step 2 is denoted as residue II and comprises a substantial amount of hemicellulose, which is then extracted in step 3.

Step 3: The residue II is extracted by high alkaline condition (in the range 1-7M NaOH) and optionally including in the range 0.5-3M Urea, using an ultrasonicator as before. The extracts are passed through a filtration system (ultrafiltration) to separate soluble and insoluble materials. The insoluble material is again extracted in the same conditions and filtered to remove insoluble material.

Step 4: At least part of the lignins present in one or more of the fractions from the mild alkaline soluble fractions (Filtrate/supernatant from Step 2) and high alkaline soluble fractions is recovered by alkaline ethanol extraction. The pH of said or each respective fraction is increased by NaOH or KOH to pH in the range 8 to 12 and two volumes of ethanol added and the mixture kept under stirring for 6 hours, then passed through a filtration system to separate soluble and insoluble fractions. The high alkaline conditions enhance the solubility of lignin and ethanol is a suitable medium to solubilise lignin whereas polysaccharides and proteins are essentially insoluble in ethanol.

Step 5: The filtrate/supernatant from the mild alkaline extraction is reduced in pH to acidic pH to separate an acid-soluble liquid fraction that comprises polysaccharides from a precipitated fraction comprising proteins and lignins; the precipitated fraction (“Residue III”) is subjected to delignification, separating therefrom a lignin-rich fraction from a protein-rich fraction, the protein-rich fraction is then preferably desalted to form “Product 3”.

The alkaline-ethanol soluble fractions from mild alkaline soluble fractions and high alkaline soluble fractions are referred to as LI and LII, respectively. The insoluble fractions from each fraction (i.e. residue IV and residue V) are, respectively, dissolved in alkaline solution, and excess colour can optionally be removed by decolouration with hydrogen peroxide. The material (which may or may not be decolourised) is neutralised with hydrochloric acid and excess salt removed by ultrafiltration using a 1 to 3 kDa membrane. The 1 to 3 kDa membrane removes the small molecules including salts but retains macromolecules (i.e. polysaccharides and proteins).

The desalted mild-acid soluble polysaccharides (supernatant I), mild-alkali soluble proteins (residue IV) and high alkaline soluble polysaccharides (residue V) are, respectively, dried using a drying device such as a rotary drum scraper dryer, belt dryer, spray dryer or freeze dryer and turned into powdered material via a pulveriser. The final extracted and dried material is similar in feel and touch to brown algal alginates. These respective product streams are referred to in FIG. 1 as product 1 (from supernatant I, which may pooled with acid-soluble fraction of supernatant II from step 2, as shown in FIG. 1); product 2 (from Residue V), and product 3 (from Residue IV).

The alkaline ethanol soluble fractions comprising lignins are passed through ethanol recovery apparatus to recover the ethanol and obtain lignin in alkaline aqueous solution. The pH of lignin containing solutions is then reduced (to pH<2) and this precipitates the lignin. (Lignin is insoluble in water at neutral or acidic pH). The precipitated lignin is recovered by filtration and washed with acidified water. This is referred to as products 4a and 4b in FIG. 1, these may be pooled to form one product 4.

With the above process we have utilised 79% of the original left-over or spent biomass after astaxanthin extraction in the above-mentioned steps as recovered fractions. The 21% that is left includes salts and soluble compounds that are lost within the output water-stream from the extraction process.

### Analytical Results

We have analysed key fractions.
Residue II (“R2”)
Residue III (“R3”)
Pooled and delignified supernatant I (“S1”)

TABLE 1
main components (% of dry weight)

| | | | Acid | | | |
|---|---|---|---|---|---|---|
| | Total | Klason | soluble | | | |
| | sugars | Lignin | Lignin | Extractives* | Starch | Ash |
| S1 | 7.5 | 3.52 | 0.45 | 76.9 | 55.4 | 1.9 |
| R2 | 8.3 | 11.4 | 5.10 | 32.5 | 8.7 | 18.5 |
| R3 | 69.1 | 15.1 | 1.24 | 11.6 | 1.4 | 2.9 |

TABLE 2
Sugar composition (% of total sugars)

| | Glucan | Xylan | Mannan | Arabinan | Galactan | Rhamnan |
|---|---|---|---|---|---|---|
| S1 | 45.7 | 1.24 | 48.5 | 0.73 | 3.23 | 0.32 |
| R2 | 24.6 | 2.92 | 59.6 | 2.15 | 9.39 | 1.21 |
| R3 | 1.8 | 2.16 | 94.9 | 0.40 | 0.59 | 0.08 |

TABLE 3
Ultimate Analysis of Acid Hydrolysis
Residue (Acid Insoluble Residue” AIR*)

| | Carbon | Hydrogen | Nitrogen | Sulphur | Protein |
|---|---|---|---|---|---|
| S1 | 44.1 | 5.95 | 1.18 | 0.51 | 7.38 |
| R2 | 48.8 | 5.66 | 5.43 | 1.66 | 33.9 |
| R3 | 22.2 | 2.67 | 0.83 | 0.12 | 5.21 |

*The Acid Insoluble Residue (AIR) is the proportion of a sample that is not hydrolysed by 72% sulphuric acid. It is equal to the sum of the Klason Lignin content and the Acid Insoluble Ash content.

TABLE 4
Adjusted Cellulosic Content (% dry mass ash-free basis)

| | | | | Total |
|---|---|---|---|---|
| | Cellulose | Hemicellulose | Lignin | Lignocellulose |
| S1 | 3.49 | 4.14 | 4.04 | 11.7 |
| R2 | 2.51 | 7.71 | 20.22 | 30.4 |
| R3 | 1.30 | 69.9 | 16.8 | 88.0 |

Residue II contains (based on % dry weight) 69% total sugars. Based on ultimate analysis of Acid Hydrolysis Residue (AIR), the fraction contains 5.2% proteins.

That which is claimed is:

1. A method for obtaining biomaterials from left-over microalgae biomass, comprising:
providing microalgae biomass after astaxanthin extraction;
performing a first extraction of the microalgae biomass in an acid solution to obtain a first supernatant with acid soluble materials comprising starch, and a first residue;
performing a second extraction of the first residue in a mild or weak base solution to obtain a second supernatant with mild or weak base soluble materials comprising starch, proteins, lignins, and a second residue;
performing a third extraction of the second residue with a strong base solution for extraction from the second residue of a third supernatant comprising cellulose, hemicellulose, and a first soluble lignin fraction; and
recovering lignins from the second supernatant and third supernatant with an alcohol solution producing a first and second soluble lignin fraction, a fourth residue comprising the cellulose and the hemicellulose, and a fifth residue comprising proteins.

2. The method of claim 1, wherein the microalgae biomass comprises spent biomass after astaxanthin extraction from H. pluvialis.

3. The method of claim 1, wherein the first extraction comprises:
suspending the microalgae biomass in the acid solution having a pH of 3-5.5 to obtain a suspension;
ultrasonicating the suspension; and
separating the ultrasonicated suspension into the first supernatant and the first residue.

4. The method of claim 1, further comprising:
recovering an acid soluble fraction comprising proteins from the second supernatant by lowering a pH of the second supernatant; and
subsequently obtaining a third residue from the second supernatant and treating the third residue with an alcohol solution to recover lignins from a protein rich fraction.

5. The method of claim 3, wherein the first supernatant comprises starch, cellulose, hemicellulose, proteins, and lignins.

6. The method of claim 4, comprising adding alcohol to the first supernatant to precipitate polysaccharides and decolorizing by adding alkaline hydrogen peroxide solution.

7. The method of claim 1, wherein the second extraction comprises:
suspending the first residue in the mild or weak base solution having a pH of about 7 to about 8 to form a suspension;
ultrasonicating the suspension; and
separating the ultrasonicated suspension into the second supernatant and the second residue.

8. The method of claim 4, further comprising
adding acid to the second supernatant to lower the pH of the second supernatant to about 3.5 to about 4.5 to precipitate proteins and lignins and form an acid soluble fraction;
separating the acid soluble fraction; and
pooling the acid soluble fraction with said first supernatant.

9. The method of claim 8, wherein the precipitated proteins and lignins are suspended in alkaline alcohol for recovery of lignins.

10. The method of claim 1, wherein a suspension of the second residue in the strong base solution is ultrasonicated and separated to desalt an extracted fraction comprising macromolecules.

11. The method of claim 1, wherein the first supernatant forms a product comprising biomolecules with film-forming properties.

12. The method of claim 1, wherein:
the first and second soluble lignin fractions are pooled;
fractions comprising starch from the first supernatant and an acid soluble fraction from the second supernatant are pooled to form a starch-rich fraction; and
an extract from the third extraction forms, after recovering the lignins, a fraction comprising the cellulose and hemicellulose.

13. The method of claim 12, wherein the acid soluble fraction is pooled with the first supernatant after a protein fraction has been precipitated from the acid soluble fraction.

14. The method of claim 1, further comprising combining the first supernatant and an acid soluble fraction from the second supernatant with a food grade plasticizer to obtain a biopolymer formulation, which is mixable with water to create a film-forming spray.

15. The method of claim 1, further comprising combining the first and second soluble lignin fractions, to obtain a biopolymer product which is compounded into pellets that can be molded into biodegradable plastics or plastics ingredients.

16. The method of claim 1, further comprising combining the proteins, cellulose, and hemicellulose with a food grade plasticizer to obtain a biopolymer formulation, which is mixable with water to create a film-forming spray.

17. A biopolymer product comprising starch, hemicellulose, cellulose, lignin, and/or proteins obtained by the method of claim 1.
